(19) United States
(12) Patent Application Publication
(10) Pub. No.: US 2024/0352228 A1
(43) Pub. Date: Oct. 24, 2024

(54) NOVEL FLAME RETARDANT

(71) Applicant: Chemische Fabrik Budenheim KG, Budenheim (DE)

(72) Inventors: Bors Cajus ABELE, Mainz (DE); Thomas FUTTERER, Ingelheim (DE); David Garcia MARTINEZ, Zaragoza (ES); Sebastian MOSCHEL, Groß-Gerau (DE); Tobias MOSS, Darmstadt (DE); Heiko ROCHHOLZ, Rümmelsheim (DE)

(73) Assignee: Chemische Fabrik Budenheim KG, Budenheim (DE)

(21) Appl. No.: 18/580,922

(22) PCT Filed: Jul. 22, 2022
(86) PCT No.: PCT/EP2022/070676

§ 371 Date: Jan. 19, 2024

(30) Foreign Application Priority Data
Jul. 26, 2021 (DE) 10 2021 119 326.5

(51) Int. Cl. C08K 5/3492

(52) U.S. Cl. CPC C08K 5/34928

(57) ABSTRACT

The invention relates to a flame retardant, a plastic composition comprising this flame retardant, and a polyphosphate salt.

### BACKGROUND OF THE INVENTION

For providing plastics with flame protection, numerous substances are known, which can be used alone or in combination with further substances that provide similar or synergistic flame-protection properties.

For example, the use of polyphosphate salts of 1,3,5-triazine compounds for such applications is known from the prior art. By means of plastic extrusion, these compounds are in particular incorporated into polyamides and polyesters (with and without glass fibres), which are typically processed in injection moulding, i.e., at elevated temperatures.

From WO 00/02869 A1, such polyphosphate salts of 1,3,5-triazine compounds are known that have an average degree of condensation (number average)>20 and a molar ratio of triazine compound to phosphorus (M/P) of <1.1.

EP 0 974 588 B1 describes 1,3,5-triazine derivatives of poly acids containing phosphorus, sulphur, and oxygen as well as a method for producing them. The ratio of 1,3,5-triazine compound to phosphorus in the disclosed triazine polyphosphate derivatives is >1.1.

EP 1 095 030 B1 also describes a polyphosphate salt of a 1,3,5-triazine compound. This salt has a 1,3,5-triazine content of 1.1 to 2.0 mol of a triazine compound selected from the group consisting of melamine, melam, melem, melon, ammeline, ammelide, 2-ureidomelamine, acetoguanamine, benzoguanamine, and diaminophenyl triazine, per mole of phosphorus atom.

These polyphosphate salts known from the prior art generally only achieve a moderate flame-protection effect upon incorporation into a composition to be protected. In addition, these phosphate salts tend to migrate from the material overtime. This not only further reduces the flame-protective effect, but the release is also associated with health risks, in particular in household applications. In addition, processing the product using an extruder, especially at temperatures above 250° C., results in decomposition of the flame retardant and a rough surface of the extruded material. This effect is particularly pronounced when the flame retardant is incorporated into a fibreglass-reinforced plastic. The processing is particularly difficult when even further synergistic flame retardants, for example products based on phosphinates, such as aluminium diethyl phosphinate, are contained in addition to the primary flame retardant and the fillers.

### OBJECT

In light of this, the object of the present invention was therefore to provide a preferably halogen-free, environmentally friendly, and in particular recyclable flame retardant based on a polyphosphate salt of the aforementioned type, which flame retardant has similar or even better flame-protection properties than those known from the prior art and in addition has a lower migration tendency so that durable and harmless flame protection can be achieved, in particular for polymeric materials. The present invention is moreover intended to ensure unlimited processability of the polymeric material containing the flame retardant, even in multi-step processing, even at high temperatures.

### DESCRIPTION OF THE INVENTION

This object is achieved by a flame retardant according to claim 1.

The flame retardant according to the invention comprises at least one polyphosphate salt comprising cations of at least one 1,3,5-triazine compound, wherein one of these 1,3,5-triazine compounds is melamine. This is thus a polyphosphate salt of a 1,3,5-triazine compound. Preferably, the polyphosphate salt comprises cations of two or more 1,3,5-triazine compounds. The “cations of at least one 1,3,5-triazine compound” of the polyphosphate salt are preferably the corresponding cations of the 1,3,5-triazine compound(s) obtained by protonation. In general, these are the corresponding ammonium ions of the mostly amino-group-containing 1,3,5-triazine compound(s), such as melamine, melam, or melem.

According to the invention, the flame-retardant furthermore comprises at least one condensation product, i.e., one or more condensation products, of melamine.

The term “condensation product” of melamine refers to molecules that are formed by a condensation reaction of two or more melamine molecules, such as melam, melem, or melon. Also encompassed by the term are the protonated forms of these compounds, i.e., the corresponding cations obtained by protonation.

In a preferred embodiment of the invention, the flame retardant according to the invention has such a cationic form of a condensation product of melamine, wherein this cation is preferably a cation of the polyphosphate salt, i.e., another one of the at least one 1,3,5-triazine compound of the polyphosphate salt. Thus, the polyphosphate salt then comprises at least cations of melamine and a condensation product of melamine, such as melam. In this case, the flame retardant may consist exclusively of the polyphosphate salt. Such a polyphosphate salt may be obtained by adding the condensation product of melamine during preparation.

In another embodiment, the flame retardant, which contains the condensation product of melamine in the form of a cation bonded to the polyphosphate salt, may comprise even further components.

However, the condensation product may also be present in the flame retardant as an additional component to the polyphosphate salt, so that the flame retardant is a composition comprising both the polyphosphate salt and the condensation product of melamine and, where appropriate, further components. In such a composition, the condensation product may be present in non-ionic form and/or as a cation of a salt that is not the polyphosphate salt.

Of course, the flame retardant may also constitute a combination of the above embodiments, i.e., one of the cations of the polyphosphate salt is the protonated form of a condensation product of melamine and the flame retardant comprises, as an additional component, at least one condensation product of melamine in non-ionic form and/or as a cation of an additional salt.

The polyphosphate salt of the flame retardant according to the invention may be described in simplified form by the following general formula:

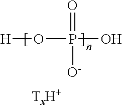

where “Tₓ” represents at least one 1,3,5-triazine compound and “n” indicates the average degree of condensation. The chain ends of the polyphosphate salt (formed in the above structural formula by —H or —OH) may also be formed by a 1,3,5-triazine compound.

The inventors were able to determine that the combination according to the invention of a polyphosphate salt comprising cations of melamine and at least one condensation product of melamine exhibits particularly pronounced flame-protection properties. In addition, the migration behaviour of the polyphosphate salt is advantageously influenced by such a combination, i.e., the polyphosphate salt is washed out of the material to be protected, in particular out of a polymeric material, to a significantly lesser extent.

Without being bound by this theory, the inventors assume that the condensation product of melamine bridges the individual macromolecules of the polyphosphate salt to one another via hydrogen bridge bonds, i.e., larger supramolecular agglomerates that migrate from the material with significantly more difficulty are formed by the intermolecular interactions. The condensation product therefore acts as a type of “supramolecular cross-linker” and thus reinforces the anchoring of the flame-retardant polyphosphate salt in or on the matrix material to be protected, in which the flame retardant is incorporated or to which it is applied.

The at least one condensation product of melamine moreover stabilizes the polyphosphate salt. For example, in synergistic combinations with acidic flame retardants, such as the aforementioned aluminium phosphinates, acid-base exchange reactions do not take place so that these combinations can be used even at high temperatures, as are common with extrusion, without decomposition of the polyphosphate salt.

With pure melamine polyphosphate, the melamine cation can, on the other hand, be replaced by the more acidic aluminium cation in the first step. The melamine may then, where applicable, sublimate and release phosphinic acid.

In addition, condensed melamine derivatives have a significantly higher decomposition temperature (>600° C.) and are therefore more stable than melamine (decomposition temperature>350° C.) during plastics processing.

The flame retardant according to the invention consequently ensures unlimited processability of the plastic, even during processing over several process steps and at high temperatures.

While the flame-protected plastic is reformed and processed several times within the value chain (extrusion, injection moulding, etc.), the physical properties of the plastic are not or only insignificantly changed.

In addition, plastics containing flame retardants according to the invention are also outstandingly suited for being recycled in a targeted circular economy for plastics, since toxic and/or almost nonbiodegradable flame retardants can be dispensed with.

Particularly preferably, the at least one condensation product of melamine is contained in the flame retardant as one of the cations of the polyphosphate salt, i.e., the condensation product of melamine is one of the at least one 1,3,5-triazine compound, the cations of which the polyphosphate salt comprises.

Such a polyphosphate salt may be represented by the following structural formula:

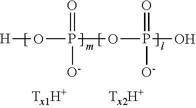

where “Tₓ₁” is melamine and “Tₓ₂” is the condensation product of melamine, such as melam. The chain ends of the polyphosphate salt (formed in the above structural formula by —H or —OH) may also be formed by a 1,3,5-triazine compound. One of the possible resonance structures of the protonated form of melam, i.e., of a possible Tₓ₂H⁺, is shown below:

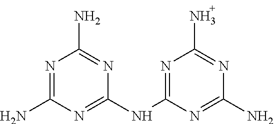 [SMILES: Nc1nc(N)nc(Nc2nc(N)nc(N)n2)n1]

One of the possible resonance structures of the protonated form of melem, i.e., of a possible Tₓ₂ H⁺, is shown below:

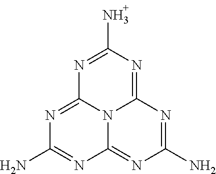 [SMILES: NC1=NC2=NC(N)=NC3=NC(N)=NC(=N1)N23]

In embodiments in which the condensation product of melamine is one of the cations of the polyphosphate salt, the effects according to the invention are particularly pronounced. Without being bound by this theory, the inventors assume that by the binding that already exists in this case to at least one macromolecule of the polyphosphate salt, supramolecular agglomerates can be formed more easily with further macromolecules of the polyphosphate salt, which increase the stability during processing.

In a particularly preferred embodiment of the invention, the flame retardant has a minimum content of the amount of substance of the condensation product in relation to the amount of substance of the cation of melamine of the polyphosphate salt.

The amount of substance of the cation of melamine contained in the flame retardant is X, the amount of substance of the condensation product of melamine contained in the flame retardant (e.g., as a cation of the polyphosphate salt) is Y. The sum of these two components consequently results from X+Y. The proportion of the amount of substance of the condensation product in this sum is preferably at least 0.1%, i.e.,

$$\frac{Y}{X + Y} \geq 0 , 001$$

More preferably, the proportion of the amount of substance of Y is at least 1%, more strongly preferably at least 2%, particularly preferably at least 3%, even more strongly preferably at least 5%, and most preferably at least 10%.

Preferably, the proportion of the amount of substance of Y is at most 50%, more strongly preferably at most 20%, particularly preferably at most 15%, even more strongly preferably at most 12%, and most preferably at most 10%.

The proportion of the amount of substance of Y is preferably in the range of 0.1 to 20%, more strongly preferably in the range of 1 to 15%, even more strongly preferably in the range of 2 to 12%, and most preferably in the range of at most 5 to 10%.

The average degree of condensation n of the polyphosphate salt is preferably at least 10, more strongly preferably at least 20, even more strongly preferably at least 50, and most preferably at least 100. A higher degree of condensation enhances the effect according to the invention since larger agglomerates of polyphosphate salt and condensation product are produced as a result and the migration tendency of the polyphosphate salt is thus even further reduced.

The average degree of condensation n of the polyphosphate salt may be determined according to known methods, for example using NMR spectroscopy, J. Am. Chem. Soc. 78, 5715 (1956).

The average degree of condensation is also referred to as the average chain length of the polyphosphate salt.

The condensation product of melamine is preferably selected from the group consisting of melam, melem, or melon. Due to its linear structure, melam is particularly suitable for linking the macromolecules of the polyphosphate salt and is therefore particularly preferred.

A 10 wt % aqueous slurry of the flame retardant comprising the polyphosphate preferably has a pH value at 25° C.≥5. The pH value is determined in a 10 wt % aqueous slurry of the flame retardant according to the invention by stirring 25 g of the flame retardant and 225 g of pure water of 25° C. in a vessel and determining the pH value of the produced aqueous suspension using conventional means, such as a pH meter or an indicator paper. Particularly preferably, the pH value is in the range of 5 to 10, more strongly preferably 5 to 8, and most preferably 5 to 7.

Preferably, a 10 wt % aqueous slurry of the polyphosphate of the flame retardant according to the invention has a pH value at 25° C. a 5. Particularly preferably, the pH value is in the range of 5 to 10, more strongly preferably 5 to 8, and most preferably 5 to 7.

By a pH value of the flame retardant and/or of the polyphosphate salt in the above-defined ranges, interactions with the matrix material to be protected, including the synergistic flame retardants contained therein, are kept as low as possible. As a result, the flame retardant may be used in a variety of different matrix materials, particularly in pH-sensitive matrix materials.

The flame-protective activity, and in particular the stability of the flame retardant during processing, may be improved by controlling the amount-of-substance ratio of the sum of the amounts of substance of the at least one 1,3,5-triazine compound and the amount of substance of the condensation product to the amount of substance of phosphorus of the polyphosphate salt. This ratio is also referred to in the relevant literature as the M/P ratio. In the sum of the amounts of substances of the at least one 1,3,5-triazine compound and the amount of substance of the condensation product of melamine, the protonated forms, such as the protonated form of melamine bound to the polyphosphate salt, are also taken into account.

The inventors were able to determine that at an M/P ratio of ≤1.3, preferably ≤1.2, more strongly preferably ≤1.1, particularly good flame-protective properties and outstanding processability of the protected polymeric material are obtained.

The polyphosphate salt according to the invention does not exclusively need to comprise cations of the at least one 1,3,5-triazine compound but can also comprise further cations, for example ammonium ions. However, in order to maximize the flame-protective effect, the majority of the cations are preferably formed from cations of the at least one 1,3,5-triazine compound.

In a particularly preferred embodiment, the proportion of the amount of substance of the cations of the at least one 1,3,5-triazine compound in the amount of substance of the cations of the polyphosphate salt is preferably ≥50%, more strongly preferably ≥70%, even more strongly preferably ≥ 80%, particularly strongly preferably ≥90%, and most preferably ≥95%. In one embodiment, the polyphosphate salt comprises exclusively cations of the at least one 1,3,5-triazine compound.

The proportion of the amount of substance of the cations of melamine in the cations of the at least one 1,3,5-triazine compound is preferably ≥50%, more strongly preferably ≥70%, even more strongly preferably ≥80%, and most preferably ≥90%.

To the extent that the polyphosphate salt comprises cations of a condensation product of melamine, the proportion of the amount of substance of these cations in the amount of substance of the cations of the polyphosphate salt is preferably ≥5%, more strongly preferably ≥10%, even more strongly preferably ≥15%, and most preferably ≥20%.

As already described, the polyphosphate salt according to the invention is characterized by a particularly advantageous migration behaviour and a high stability during processing. Even by solvents such as water, the flame-retardant according to the invention cannot be removed or can only be removed to an extremely small extent from the matrix material into which the flame-retardant is incorporated. This effect is particularly strongly pronounced when the flame retardant according to the invention has an extremely low water solubility. This is of paramount importance for plastic products, in particular in the outdoor area or in applications with high room moisture.

The water solubility of the flame retardant according to the invention is preferably below 0.1 g/100 ml, more strongly preferably ≤0.05 g/100 ml. In this context, the water solubility is determined by preparing a 10 wt % aqueous slurry of the flame retardant in water at 25° C. and measuring after 24 hrs how much of the flame retardant according to the invention has dissolved in water.

The water solubility of the polyphosphate salt of the flame retardant according to the invention is preferably below 0.1 g/100 ml, more strongly preferably ≤0.05 g/100 ml.

The flame retardant according to the invention is characterized by an exceptionally high decomposition temperature. The decomposition temperature may be determined by thermogravimetric analysis (TGA).

In a preferred embodiment of the invention, the decomposition temperature, i.e., the temperature at which a loss of mass of the dry flame retardant of 2 wt % occurs at a heating rate of 10 K/min in a DSC measurement, is above 300° C., particularly preferably above 320° C., even more strongly preferably above 350° C.

Preferably, the decomposition temperature of the polyphosphate salt of the flame retardant according to the invention, i.e., the temperature at which a loss of mass of the dry flame retardant of 2 wt % occurs at a heating rate of 10 K/min in a DSC measurement, is above 300° C., particularly preferably above 320° C., even more strongly preferably above 350° C.

In a preferred embodiment, the flame retardant contains at least one further flame-retardant component, which is preferably selected among nitrogen bases, melamine derivatives, phosphates, pyrophosphates, polyphosphates, organic and inorganic phosphinates, organic and inorganic phosphonates, and derivatives of the aforementioned compounds, preferably selected under ammonium polyphosphate, ammonium polyphosphate particles coated and/or coated and cross-linked with melamine, melamine resin, melamine derivatives, silanes, siloxanes, silicones, or poly-styrenes, as well as 1,3,5-triazine compounds, including melamine, melam, melem, melon, ammeline, ammelide, 2-ureidomelamine, acetoguanamine, benzoguanamine, diaminephenyl triazine, melamine salts and adducts, melamine cyanurate, melamine borate, melamine orthophosphate, melamine pyrophosphate, dimelamine pyrophosphate, aluminium diethyl phosphinate, melamine polyphosphate, oligomeric and polymeric 1,3,5-triazine compounds, and polyphosphates of 1,3,5-triazine compounds, guanine, piperazine phosphate, piperazine polyphosphate, ethylenediamine phosphate, pentaerythritol, dipentaerythritol, borophosphate, zinc borate, zinc phosphate, zinc pyrophosphate, 1,3,5-trihydroxy ethyl isocyanurate, 1,3,5-triglycidyl isocyanurate, triallyl isocyanurate, and derivatives of the aforementioned compounds. In a preferred embodiment, the flame retardant contains waxes, silicones, siloxanes, fats, or mineral oils for better dispersibility of the further flame-retardant component.

The flame retardant according to the invention may also contain further polyphosphate salts, wherein the polyphosphate salt preferably comprises cations of at least one 1,3,5-triazine compound.

In addition, inorganic pigments and fillers (TiO₂, Al₂O₃, Ba₂SO₄, or the like) may be contained in the flame retardant according to the invention. Particularly preferred are inorganic pigments that are used for laser welding, laser marking, or laser structuring. Mentioned by way of example are copper salts, such as copper hydroxide phosphate, copper pyrophosphate, or similar agents.

Particularly preferably, the flame retardant according to the invention comprises at least one compound selected from the group consisting of phosphinates, diphosphinates, such as aluminium diethyl phosphinate, zinc borates, and zinc phosphates.

In a preferred embodiment, the ratio of polyphosphate salt to the at least one further flame-retardant component in the flame retardant is 1:18 to 1:4, more strongly preferably 1:9 to 1:2, even more strongly preferably 1:6 to 1:1.5, and particularly preferably 1:4 to 1:1.25.

Particularly preferably, the flame retardant according to the invention is halogen-free. The term “halogen-free” in this context means that the weight proportion of halogen in the weight of the flame retardant is ≤1 wt %, preferably ≤0.5 wt %, particularly preferably ≤0.2 wt %, and most preferably ≤0.1 wt %.

In a preferred embodiment of the invention, the polyphosphate salt of the flame retardant is halo-gen-free, i.e., it has a halogen content of ≤1 wt %, preferably ≤0.5 wt %, more strongly preferably ≤0.2 wt %, and most preferably ≤0.1 wt %.

The present invention also relates to a plastic composition comprising a plastic matrix and the flame retardant according to the invention. The term “matrix” within the meaning of this invention comprises any material, in particular any plastic or any mixture of plastics, into which the flame retardant according to the invention can be incorporated or to which the flame retardant according to the invention can be applied as a coating. The term “plastics” is understood to include materials consisting of ≥50 wt %, preferably ≥70 wt % macromolecules.

The term “macromolecules” refers to molecules constructed from one or more of the same or similar structural units, the constitutional repetition units (IUPAC. Compendium of Chemical Terminology, 2nd ed. (the “Gold Book”), A. D. McNaught, A. Wilkinson, Blackwell Scientific Publications, Oxford (1997), S. J. Chalk. ISBN 0-9678550-9-8). Such macromolecules have more than 10 repetition units, preferably more than 15 repetition units. The molar mass is preferably at least 3,000 g/mol, more strongly preferably at least 5,000 g/mol, even more strongly preferably at least 7,000 g/mol, and most preferably at least 10,000 g/mol.

Plastics containing the, preferably halogen-free, flame retardant according to the invention are outstandingly suited to be returned to circulation and recycled after use. In particular if they contain no or only a low proportion of halogens.

It has been shown that flame retardants according to the invention can in particular be used advantageously in the production of plastic compositions in the extrusion method. Without significantly affecting the processing properties of the different plastic matrices, the flame retardants according to the invention can be incorporated easily in these methods. When using the flame retardants according to the invention, the thermal and mechanical properties of the plastic matrix after processing are also affected only little.

Plastic matrices in which the flame retardant can be used are preferably selected among filled and unfilled vinyl polymers, olefin copolymers, thermoplastic elastomers based on olefin, cross-linked thermoplastic elastomers based on olefin, polyurethanes, filled and unfilled polyesters and copolyesters, styrene block copolymers, filled and unfilled polyamides and copolyamides, copolycarbons, and poly(meth)acrylates. The use in polymethacrylates and polyacrylates particularly preferable, most preferably in polymethyl methacrylates. In this context, it is particularly advantageous that the addition of the flame retardant according to the invention results in a transparent polymethacrylate or polyacrylate.

In principle, however, the flame retardants according to the invention can be used for all plastic matrices. They are suitable for polyamides (PA), polyesters, such as polybutylene terephthalate (PBT), polyethylene terephthalate (PET), polyolefins, such as polypropylene (PP), polyethylene (PE), polystyrene (PS), styrene block copolymers, such as ABS, SBS, SEES, SEPS, SEEPS, and MBS, polyurethanes (PU), in particular hard and soft PU foams, poly(meth)acrylates, polycarbonates, polysulphones, polyether ketone, polyphenylene oxide, polyphenylene sulphide, epoxy resins, polyvinyl butyral (PVB), polyphenylene oxide, polyacetal, polyoxymethylene, polyvinyl acetal, polystyrene, acryl butadiene styrene (ABS), acrylonitrile styrene acryl ester (ASA), polycarbonate, polyhydroxy alkanoate (PHA), polybutylene succinate (PBS), polyether sulphone, polysulphonate, polytetrafluoroethylene (PTFE), polyurea, formaldehyde resins, melamine resins, polyether ketone, polyvinylchloride, polylactic acid, silicones, polysiloxane, phenolic resins, poly(imide), bismaleimide triazine, thermoplastic elastomers (TPEs), Thermoplastic urethane-based elastomers (TPU-U), thermoplastic polyurethane, copolymers, rubbers, and/or mixtures of the aforementioned polymers.

The use of the flame retardant according to the invention in plastic matrices that are processed at particularly high temperatures, for example polyamides or polyesters is particularly suitable; the use in PA 6.6 or PA 6 or also in the high-temperature polyamides, such as polyamide 4.6, semi-aromatic polyamides, and polyamide 12, is particularly preferable. Due to the high thermal stability of the flame retardant according to the invention, it can also be used for such plastics. The use in technical plastics that are fibreglass-reinforced, in particular fibreglass-reinforced PA 6, PA 66, fibreglass-reinforced blends of the same, and fibreglass-reinforced PBT is particularly preferable.

In a preferred embodiment, the plastic matrix is selected among filled or unfilled and/or reinforced polyamides, polyesters, polyolefins, and polycarbonates. A filled plastic matrix is understood to mean a plastic matrix containing one or more fillers, in particular those selected from the group consisting of metal hydroxides, in particular alkaline earth metal hydroxides, alkali metal hydroxides, and aluminium hydroxides, silicates, in particular phyllosilicates and functionalized phyllosilicates, such as nanocomposites, bentonite, alkaline earth metal silicates, and alkaline metal silicates, carbonates, in particular calcium carbonate, as well as talc, clay, mica, silica, calcium sulphate, barium sulphate, aluminium hydroxide, magnesium hydroxide, glass fibres, glass particles, and glass balls, wood flour, cellulose powder, soot, graphite, boehmite, and colourants.

All of the fillers listed may be present both in the conventional shape and size of fillers known to the person skilled in the art and in nanoscale form, i.e., as particles having an average diameter in the range of approximately 1 to approximately 200 nm, and can be used in the plastic compositions.

In order to strengthen the plastic composition and to increase its mechanical stability, glass fibres are preferably added as filler.

In a preferred embodiment, the flame retardant is introduced in an amount of 1 to 40 wt %, more strongly preferably between 1 and 30 wt %, particularly preferably 1 to 25 wt %, based on the total weight of the plastic composition with flame retardant.

These quantity ratios provide a good flame-protection effect while preventing a significant change in the properties of the plastic matrix both during processing and in use, in particular in terms of mechanical properties and thermal dimensional stability.

The flame retardant can be introduced into the matrix material to be protected, in particular the plastic matrix material, by various methods. First of all, the flame retardant can be incorporated into the moulding process. If the plastic matrix material is processed by extrusion, for example, the flame retardant can be supplied in the extrusion process, e.g., as an easily dosable powder blend, as a granule or by means of a masterbatch. A masterbatch within the meaning of the present invention is a polymeric material, in the form of granules or powder, containing the flame retardant and the possibly further additives in concentrations that are higher than in the final application. In order to prepare the plastic composition, the masterbatch or various masterbatches are combined with plastic matrix material without the flame retardant contained in the masterbatch in such amounts or ratios that the final product has the desired concentration of the flame retardant. Compared to the addition of various substances in the form of pastes, powders, or liquids, masterbatches have the advantage that they ensure a high level of process safety and are very well suited for processing and dosing. Through extrusion, the flame retardant is evenly distributed in the plastic matrix.

The introduction of the composition into the polymeric material can be demonstrated by suitable analysis techniques, in particular NMR spectroscopy or IR spectroscopy.

The invention also relates to a polyphosphate salt as defined in claims 1 to 10, preferably claims 2 to 10, in particular to a polyphosphate salt comprising cations of at least two 1,3,5-triazine compounds, wherein one of the at least one 1,3,5-triazine compound is melamine, and wherein another of the at least two 1,3,5-triazine compounds is a condensation product of melamine, preferably melam.

The invention also relates to the use of a condensation product of melamine to increase the flame-protection effect and/or the stability and/or processability of a polyphosphate salt preferably comprising cations of melamine.

The invention also relates to the use of the flame retardant according to the invention for providing materials, in particular plastic materials, preferably thermoplastic plastic materials, with flame protection.

The present invention also relates to the use of a flame retardant according to the invention as a coating material, preferably as a coating material for wood, metal, or a plastic matrix material. Particularly preferred is the use for so-called natural-fibre-reinforced plastics, preferably wood-plastic composites, i.e., composite materials made of wood fibres and plastics. Coating is understood to mean a method in accordance with DIN 8580 in which an adherent layer of formless material is applied to the surface of a workpiece.

### EXAMPLES

### Starting Materials:

| Name | Manufacturer | Purity/Mₙ | CAS |
|---|---|---|---|
| Phosphoric Acid | FOSFA | 85 wt % | 7664-38-2 |
| | | in water | |
| Melamine | BASF | 99.9 wt % | 108-78-1 |
| Melam | — | 99.9 wt % | 3576-88-3 |
| Aluminium diethyl | Clariant | 99.9 wt % | 225789-38-8 |
| phosphinate Exolit | | | |
| OP 1230 | | | |

### Measurement Methods:

### UL94 Test

Per measurement, 5 specimens were clamped in a vertical position and held to the free end of a Bunsen burner flame. The combustion time and also the dropping of burning parts were evaluated using a cotton ball arranged under the specimen. The exact conduct of the experiments and the flame impingement with a 2 cm high Bunsen burner flame was performed in accordance with the specifications of Underwriter Laboratories, Standard UL94.

The classifications in the fire protection classes V-0 to V-2 are given as results. In this respect, V-0 means that the total burning time of 5 specimens tested was less than 50 seconds and the cotton ball was not ignited by dropping annealing or burning constituents of the specimen. The classification V-1 means that the total burning time of 5 specimens tested was more than 50 seconds but less than 250 seconds and the cotton ball was also not ignited. V-2 means that although the total burning time of 5 specimens tested was less than 250 seconds, the cotton ball was ignited by dropping specimen constituents in at least one of the 5 tests. The abbreviation NC stands for “non-classifiable” and means that a total burning time of more than 250 seconds was measured. In many cases of non-classifiability, the specimen burned completely.

### Thermogravimetric Analysis

Thermogravimetric analyses (TGA) were performed using a device for simultaneous thermogravimetry—dynamic differential calorimetry (STA/TG-DSC), model STA409 PC/3/H Luxx, Netzsch Gerätebau GmbH company, in the range of 30 to 500° C. under nitrogen atmosphere with a heating rate of 10 K/min. The initial weight of the samples was 12-15 mg. The NETZSCH Proteus software was used to evaluate the TGA curves.

### pH Value Determination, Conductivity Measurement

The pH value was determined in accordance with EN ISO 787-9. For this purpose, a 10 wt % suspension of the flame retardant according to the invention was prepared in distilled water (temp. 25° C.) while shaking. Two parallel batches were produced in each case, wherein the difference in the measured pH values could not exceed 0.3 units.

A combined pH value/conductivity sensor (Mettler Toledo, SevenMulti S470 Excellence) was used for the determination so that the conductivity of the above suspension could also be determined simultaneously with the pH value.

Determination of the Bound 1,3,5-triazine Compounds

The determination of the contents of the 1,3,5-triazine compounds bound to the polyphosphate salt in ionic form, i.e., of melamine and its homologue, was carried out by means of HPLC-UV. First, the free portion of the corresponding compounds of a sample and then the total portion after hydrolysis with concentrated phosphoric acid was determined for this purpose. The content of the bound 1,3,5-triazine compounds results from the difference. For hydrolysis, between 20 and 30 mg (+/−0.1 mg) of a sample was placed on the analytical balance in a 100 ml beaker, filled up to 50.00 g with 85% phosphoric acid and kept for 30 min at 100° C.

The substances was identified in the UV range at a wavelength of 230 nm by determining the HPLC retention times on two different column phases, “reversed phase” and “strong cation exchanger” (cf. table below).

| | SYNERGI 4u Hydro-RP | PARTISIL 10-SCX |
|---|---|---|
| | Reversed phase | Cation exchanger |
| Ammeline | 2.4 +/− 0.11 min | 3.6 +/ 1.0 min |
| Ammelide | 2.5 +/− 0.11 min | 2.5 +/− 0.2 min |
| Melamine | 2.8 +/− 0.11 min | 4.6 +/− 1.0 min |
| Melem | 19.1 +/− 0.08 min | 2.9 +/− 0.2 min |
| Melam | 41.6 +/− 0.3 min | 11.8 +/− 4.0 min |

### Assessment of Processability, Flame Protection Results

The processability was determined by incorporation into PA6 with conventional processing agents during extrusion with a twin-screw extruder.

Using a Model Process 11 twin-screw extruder, Thermo Fisher Scientific Inc. company, a granulate with a grain size of approximately 3×1×1 mm was produced under the usual extrusion conditions for PA6. The extrusion process was performed at a throughput of approximately 5 kg/hr and a screw speed of 300 rpm and a temperature of the extrusion zone of approximately 280° C. The processability, in particular involving any possibly occurring non-uniformities and bubble formation, was assessed by microscopic examination.

By subsequent hot pressing, UL94-conform specimens having the flame-protection properties listed in the table below were obtained. The weight proportion of the synergistic flame protection mixture of aluminium diethyl phosphinate Exolite OP 1230 and the flame retardant according to the invention (weight ratio 2:1) was 19% each.

### Determination of M/P Proportions

The total phosphorus and nitrogen content for calculating the M/P ratio was determined as described below.

The total phosphorus content was determined via a photometric P₂O₅ measurement. For this purpose, a sample was hydrolysed using a closed acid digestion (65% nitric acid) in a microwave system at a maximum power of 1,000 Watts for a total of 30 minutes. Photometric determination was carried out at 430 nm against a reagent blank value.

Nitrogen determination was carried out titrimetrically. For this purpose, the nitrogen bound in the sample as ammonium is separated from it by destruction of the organic matrix. The oxidative acid digestion is carried out with concentrated sulphuric acid while boiling in a closed digestion device (heating bank including Turbosog). In the process, organic material is oxidatively destroyed and the SO₂ produced by reducing the concentrated sulphuric acid is removed. By adding alkaline solution, the nitrogen is subsequently transferred to a water-vapour volatile form, selectively distilled off, and volumetrically measured. The expelled amount is determined by titration with H₂SO₄.

### Preparation Examples

### Example I According to the Invention

A 100-litre reactor equipped with a stirrer was filled with 50 litres of pure water. While stirring, 19.9 kg orthophosphoric acid (85 wt % H₃PO₄) was added to the water at room temperature.

While stirring constantly, 20 kg of melamine and 7.18 kg of melam were then slowly added at 50° C. After addition, excess water was vaporized by increasing the temperature until a residual water content of ≤0.1 wt % was obtained in the mixture. The resulting phosphate salt was then heated to a temperature of 310° C., whereby the reaction to form the polyphosphate took place.

### Example II According to the Invention

A 100-litre reactor equipped with a stirrer was filled with 50 litres of pure water. While stirring, 16.2 kg of orthophosphoric acid (85 wt % H₃PO₄) was added to the water at room temperature.

While stirring constantly, 20 kg of melamine and 1.37 kg of melam were then slowly added at 50° C. After addition, excess water was vaporized by increasing the temperature until a residual water content of ≤0.1 wt % was obtained in the mixture. The resulting phosphate salt was then heated to a temperature of 310° C., whereby the reaction to form the polyphosphate took place.

### Comparative Example

A 100-litre reactor equipped with a stirrer was filled with 50 litres of pure water. While stirring, 17.4 kg of orthophosphoric acid (85 wt % H₃PO₄) was added to the water at room temperature.

While stirring constantly, 20 kg of melamine were then slowly added at 50° C. After addition, excess water was vaporized by increasing the temperature until a residual water content of ≤0.1 wt % was obtained in the mixture. The resulting phosphate salt was then heated to a temperature of 310° C., whereby the reaction to form the polyphosphate took place.

The obtained flame retardants have the following physical properties:

| | | | Comparative |
|---|---|---|---|
| Parameter | Example I | Example II | example |
| Bound melamine [wt %] | 43.4 | 43.1 | 45.1 |
| Bound melam [wt %] | 19.3 | 3.7 | <0.25 |
| M/P ratio | 1.27 | 1.21 | 1.05 |
| pH value (10 wt %) | 5.44 | 4.77 | 7.04 |
| Conductivity [mS] | 0.106 | 0.158 | 0.191 |
| TGA 1 wt % loss [° C.] | 380 | — | 369 |
| TGA 2 wt % loss [° C.] | 385 | — | 379 |
| TGA 3 wt % loss [° C.] | 389 | — | 384 |
| TGA 5 wt % loss [° C.] | 395 | — | 391 |
| Processability PA 66 | Excellent | Good | Limited |
| UL-94 | V0 1.6 mm | V0 1.6 mm | NC¹ 1.6 mm |
| | V0 0.8 mm | NC¹ 0.8 mm | |

¹Not classified

1. A flame retardant comprising a polyphosphate salt, wherein the polyphosphate salt comprises cations of at least one 1,3,5-triazine compound, wherein one of the at least one 1,3,5-triazine compound is melamine, and wherein the flame retardant comprises at least one condensation product of melamine.

2. The flame retardant according to claim 1, wherein the at least one condensation product of melamine is one of the at least one 1,3,5-triazine compound, the cations of which the polyphosphate salt comprises.

3. The flame retardant according to claim 1, wherein the amount of substance of the cations of melamine in the flame retardant is X and the amount of substance of the at least one condensation product of melamine is Y, and wherein the proportion of Y in the sum of the amounts of substance X+Y is ≥1%, preferably ≥2%.

4. The flame retardant according to claim 1, wherein the average degree of condensation n of the polyphosphate salt is 10 to 500, preferably 20 to 250.

5. The flame retardant according to claim 1, wherein the at least one condensation product of melamine is preferably selected from the group consisting of melam, melem, or melon, preferably melam.

6. The flame retardant according to claim 1, wherein the pH value of a 10 wt % slurry of the flame retardant and/or the polyphosphate salt in water at 25° C. is ≥5.

7. The flame retardant according to claim 1, wherein in said flame retardant, the amount-of-substance ratio of the sum of the amounts of substance of the at least one 1,3,5-triazine compound and the amount of substance of the at least one condensation product of melamine to phosphorus is ≤1.3, preferably ≤1.1.

8. The flame retardant according to claim 1, wherein the cations of the at least one 1,3,5-triazine compound constitute ≥90% of the total proportion of the cations of the polyphosphate salt.

9. The flame retardant according to claim 1, wherein the water solubility of the flame retardant and/or of the polyphosphate salt is ≤0.1 g/100 ml, preferably ≤0.07 g/100 ml.

10. The flame retardant according to claim 1, wherein the decomposition temperature of the flame retardant and/or of the polyphosphate salt is >320° C.

11. The flame retardant according to claim 10, further comprising, as an additional component, at least one component selected from the group consisting of phosphinates, diphosphinates, such as aluminium diethyl phosphinate, zinc borates, and zinc phosphates.

12. A plastic composition comprising a plastic matrix and a flame retardant according to claim 1.

13. A polyphosphate salt according to claim 1.

14. The flame retardant according to claim 2, wherein the amount of substance of the cations of melamine in the flame retardant is X and the amount of substance of the at least one condensation product of melamine is Y, and wherein the proportion of Y in the sum of the amounts of substance X+Y is ≥1%,
wherein the average degree of condensation n of the polyphosphate salt is 10 to 500,
wherein the at least one condensation product of melamine is preferably selected from the group consisting of melam, melem, or melon,
wherein the pH value of a 10 wt % slurry of the flame retardant and/or the polyphosphate salt in water at 25° C. is ≥5,
wherein in said flame retardant, the amount-of-substance ratio of the sum of the amounts of substance of the at least one 1,3,5-triazine compound and the amount of substance of the at least one condensation product of melamine to phosphorus is ≤1.3,
wherein the cations of the at least one 1,3,5-triazine compound constitute ≥90% of the total proportion of the cations of the polyphosphate salt,
wherein the water solubility of the flame retardant and/or of the polyphosphate salt is ≤0.1 g/100 ml, and
wherein the decomposition temperature of the flame retardant and/or of the polyphosphate salt is >320° C.
